(19) United States
(12) Patent Application Publication
(10) Pub. No.: US 2004/0188955 A1
(43) Pub. Date: Sep. 30, 2004

(54) Ring-shaped metal gasket

(76) Inventors: Kenichi Takahiro, Hamamatsu-shi (JP); Hideaki Mori, Hamamatsu-shi (JP); Katsumi Watanabe, Hamamatsu-shi (JP); Kanji Hanashima, Hamamatsu-shi (JP)

Correspondence Address: FLYNN THIEL BOUTELL & TANIS, P.C., 2026 RAMBLING ROAD, KALAMAZOO, MI, 49008-1699, US

(21) Appl. No.: 10/805,960

(22) Filed: Mar. 22, 2004

(30) Foreign Application Priority Data
Mar. 25, 2003 (JP) 2003-082501

(51) Int. Cl. F16L 17/025

(52) U.S. Cl. 277/626

(57) ABSTRACT

In order to provide a ring-shaped metal gasket that can secure a uniform sealing property over the entire surfaces of flanges regardless of the position of a bolt and a nut for tightening a clamp, a ring-shaped metal gasket is composed of an annular main body having a square cross section, a pair of annular arm portions projecting circumferentially outwardly of the annular main body in a bugle state at a predetermined angle, and an annular projecting portion bulging circumferentially inwardly with a height larger than the axial height of the annular main body. The annular projection portion acts as a positioning means. When a flange portion is tightened by a wedge action achieved by tightening a clamp, the pair of annular arm portions are elastically deformed and come into pressure contact with the flange surfaces by the elastic repulsive force thereof.

### BACKGROUND OF THE INVENTION

1. Field of the Invention

The present invention relates to the improvement of a ring-shaped metal gasket preferably used to seal the portion between flanges of a fluid transporting pipe.

2. Description of the Related Art

Heretofore, there is a hermetic seal device having such a structure that a ring-shaped metal gasket is inserted between flanges of a high-temperature fluid transportation pipe to seal the flanges by clamping the gasket with a clamp around the circumferences of the flanges.

For example, Japanese Patent Application Laid-Open No. 2001-248772 discloses a hermetic seal device that tightens a flange portion of a pipe member by the wedge action of the inner inclining surface of a clamp main body by tightening a clamp with a tightening screw or with a bolt and a nut provided with the clamp main body and reduces the diameter of the overall clamp to thereby elastically deform a seal member in the axial and radial directions of the pipe member and cause the seal member to come into close contact with flange surfaces.

In the hermetic seal device having the above structure deforms the seal member by reducing the diameter of the overall clamp by tightening with the bolt and the nut.

Accordingly, when the bolt and the nut are located at one position, since the tightening pressure of the clamp does not uniformly acts on the seal member, the seal member has a different surface pressure depending on a portion thereof, whereby a disadvantage arises in that a gap is formed between the clamp and the seal member and a leakage is caused therefrom.

Further, even if a plurality of bolts and nuts are employed, the clamp is not tightened uniformly likewise because the respective bolts and nuts do not have a uniform tightening force, thereby a gap is formed between the clamp and the gasket and a leakage is caused therefrom.

In addition to the above-mentioned, there is also a problem in that since the flanges are tightened through the clamp, a tightening force is weaker than that in the case in which the flanges are directly tightened by bolts.

When the seal member is composed of a metal gasket, the seal member is unlike to deform because it cannot absorb the distortion of the gasket itself and the flange, thereby an outstanding gap is formed between the seal member and the surfaces of the flanges.

### SUMMARY OF THE INVENTION

Accordingly, an object of the present invention is to provide a ring-shaped metal gasket that can secure a uniform sealing property over the entire surfaces of flanges of a pipe member regardless of the position of a bolt and a nut for tightening a clamp in a hermetic seal device having a structure for tightening the flanges using the clamp.

The present invention has been made to achieve the above object, and the gist of a first aspect of the invention resides in a ring-shaped metal gasket composed of an annular main body having a square cross section, a pair of annular arm portions projecting circumferentially outwardly of the annular main body in a bugle state at a predetermined angle, and an annular projecting portion bulging circumferentially inwardly of the annular main body with a height larger than the axial height of the annular main body.

A gist of a ring-shaped metal gasket according to a second aspect of the present invention resides in that the metal gasket is composed of an annular main body having a square cross section, a pair of annular arm portions projecting circumferentially inwardly of the annular main body in a bugle state at a predetermined angle, and an annular projecting portion bulging circumferentially outwardly of the annular main body with a height larger than the axial height of the annular main body.

### BRIEF DESCRIPTION OF THE DRAWINGS

FIG. 1 is a plan view of a gasket showing an embodiment of the present invention;

FIG. 2 is an enlarged sectional view taken along the line X-X of FIG. 1;

FIG. 3 is a partly enlarged sectional view of the gasket;

FIG. 4 is a sectional view showing a state of use of the gasket;

FIG. 5 is a sectional view of a gasket showing another embodiment of the present invention; and

FIG. 6 is a sectional view showing a state of use of the gasket.

### DESCRIPTION OF THE PREFERRED EMBODIMENTS

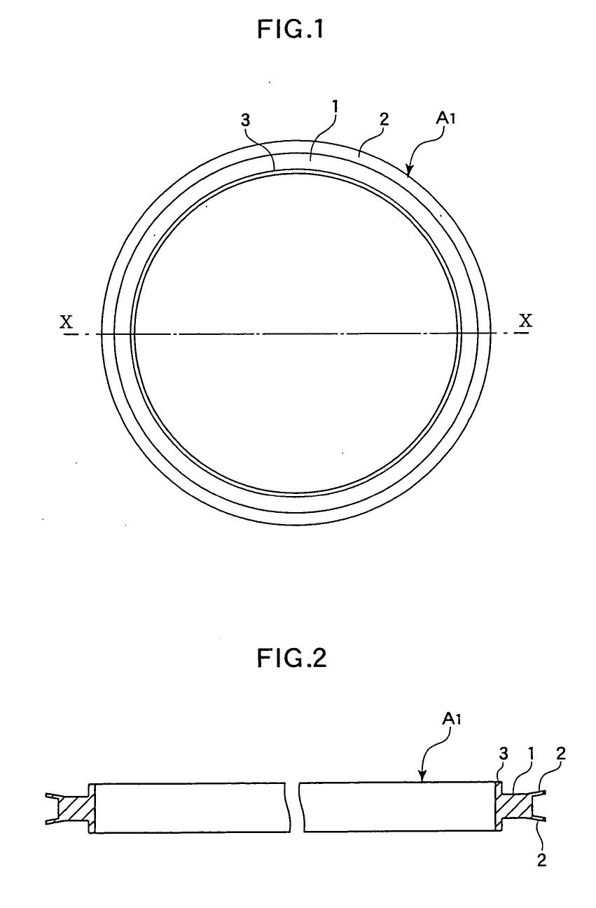

As shown in FIGS. 1 to 3, a ring-shaped metal gasket A₁ as a preferable embodiment of the present invention is composed of an annular main body 1 having a square cross section, a pair of annular arm portions 2, 2, which project circumferentially outwardly of the annular main body 1 in a bugle state at a predetermined angle, and an annular projecting portion 3 which bulges circumferentially inwardly of the annular main body with a height larger than the axial height of the annular main body 1.

A metal material such as stainless steel, inconel, and the like and materials obtained by plating or vacuum deposition soft metal such as silver, tin, and the like on the surfaces of the above metal materials can be generally used as a material for the ring-shaped metal gasket of the present invention. However, it is preferable to use stainless steel SUS 316L and the like that are excellent in corrosion resistance.

As a method of processing the gasket of the present invention, it can be processed by cutting and the like, which are well-known metal machining methods, or by a method such as die forging and the like which does not cut off a material.

In the gasket A₁ arranged as described above, it is preferable to set the projecting angle a of the pair of annular arm portions 2, 2, which project circumferentially outwardly of the annular main body 1 in the bugle state, within the range of 10° to 15°.

Further, it is preferable to set the thickness of the annular arm portions 2, 2 to 1 mm or less and particularly to 0.5 mm. It is preferable to set the projecting length of the annular projecting portion 3 to 2 mm or more.

FIG. 4 shows a state of use of the gasket. In the figure, reference symbol Al denotes the gasket, B denotes a pipe member, 4 denotes flanges, and C denotes a clamp.

When the metal gasket A₁ is interposed between the flanges 4, 4, it can be located at a predetermined position by inserting the annular projecting portion 3 into annular groove portions 5 formed on the joint surfaces of the flanges 4, 4.

After the gasket A₁ is interposed between the flanges 4, 4, the gap between the flanges 4, 4 is tightened by the clamp C, thereby the pair of annular arm portions 2, 2 are elastically deformed, and are caused to come into pressure contact with the flange surfaces by an elastic repulsive force generated at the time. The annular arm portions 2, 2 are deformed by a small load and return to original shapes when the load is released.

The annular arm portions 2, 2 are elastically deformed by tightening the flanges as described above. However, after the joint surfaces of the flanges 4, 4 come into contact with the annular main body 1, the flanges are not further tightened because the annular main body 1 acts as a spacer.

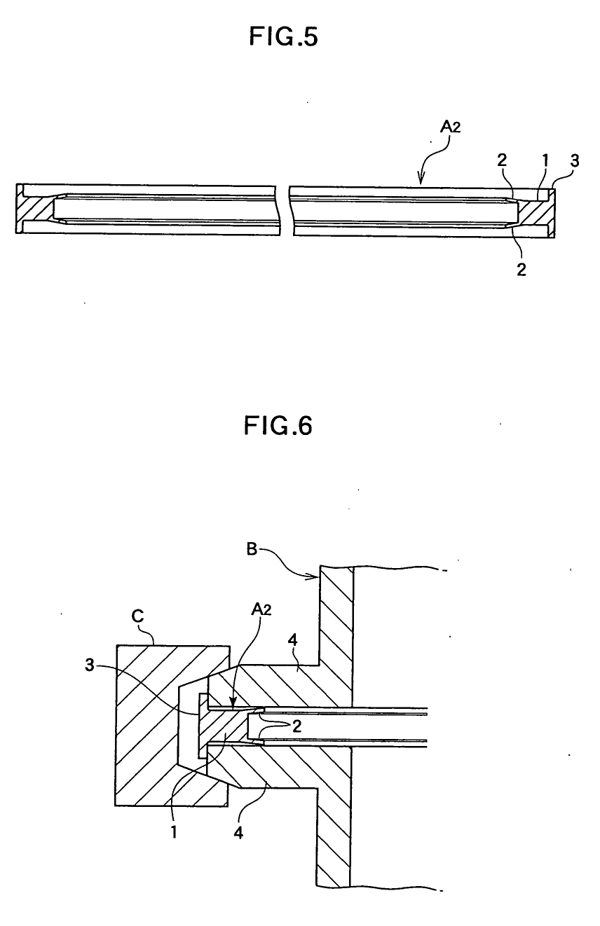

FIG. 5 shows another preferable embodiment of the present invention, and FIG. 6 shows a state of use of the embodiment.

A gasket A₂ according to the above embodiment is composed of an annular main body 1, a pair of annular arm portions 2, 2 formed circumferentially inwardly of the annular main body 1, and an annular projecting portion 3 formed circumferentially outwardly of the annular main body 1. The gasket A₂ arranged as described above is positioned by the annular projecting portion 3 abutted against the outer circumferential surfaces of flanges 4.

According to the gaskets A₁ and A₂ shown above, in a hermetic seal device having a structure for tightening the flanges of a pipe member using a clamp, it is possible to secure a uniform seal property over the entire surfaces of the flanges regardless of the position of a bolt and a nut for tightening the clamp.

### Embodiment

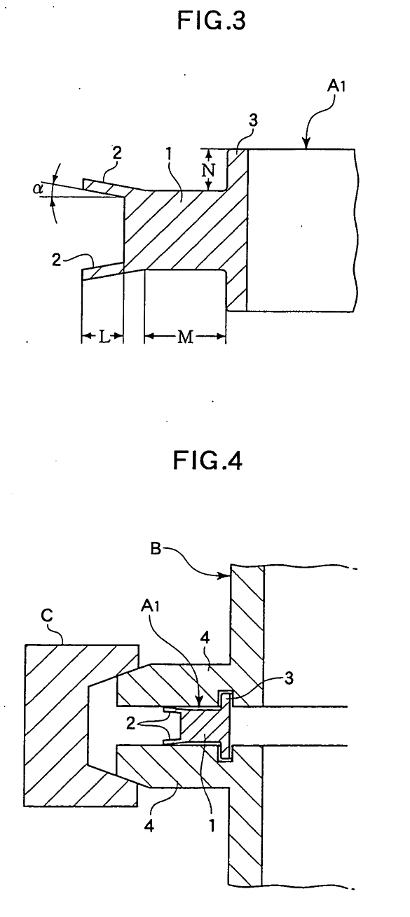

As shown in FIG. 3, a gasket main body was made by cutting a SUS 316L metal annular arm body having a square cross section. The gasket main body was composed of annular arm portions 2, 2 having a length L of 2.1 mm, an annular main body 1 having a width M of 2.5 mm, and an annular projecting portion 3 projecting in a pipe axis direction with a length L of 2.0 mm.

As described above in detail, according to the present invention, there can be obtained the ring-shaped metal gasket that can secure the uniform sealing property over the entire surfaces of flanges of a pipe member regardless of the position of a bolt and a nut for tightening a clamp in a hermetic seal device having the structure for tightening the flanges using the clamp.

What is claimed is:

1. A ring-shaped metal gasket comprising:
an annular main body having a square cross section;
a pair of annular arm portions projecting circumferentially outwardly of the annular main body in a bugle state at a predetermined angle; and
an annular projecting portion bulging circumferentially inwardly of the annular main body with a height larger than the axial height of the annular main body.

2. A ring-shaped metal gasket comprising:
an annular main body having a square cross section;
a pair of annular arm portions projecting circumferentially inwardly of the annular main body in a bugle state at a predetermined angle; and
an annular projecting portion bulging circumferentially outwardly of the annular main body with a height larger than the axial height of the annular main body.
